(19) United States
(12) Patent Application Publication
(10) Pub. No.: US 2016/0210888 A1
(43) Pub. Date: Jul. 21, 2016

(54) FABRIC BANNER HOLDER

(71) Applicant: Joe Seng Flag Co., Ltd., New Taipei City (TW)

(72) Inventor: Chih-Ming HSU, New Taipei City (TW)

(21) Appl. No.: 14/875,361

(22) Filed: Oct. 5, 2015

(30) Foreign Application Priority Data
Jan. 16, 2015 (TW) 104200750

(51) Int. Cl. G09F 17/00

(52) U.S. Cl. CPC G09F 17/00; G09F 2017/0041

(57) ABSTRACT

This invention relates to a fabric banner holder comprising two adjusting devices, which can be installed on ceiling or wall surface to hang and suspend an overhead fabric banner. The first adjusting device is a fixed assembly, while the second adjusting device has a sliding assembly with a sliding block. When both ends of a fabric banner are fixed to both adjusting devices, a rotating lever arm is used to rotate a gear and move the sliding unit in a translating motion, stretching and making taut the fabric banner. The sliding unit assembly contains a sliding blocker to keep the sliding unit locked into place, keeping the banner in tension, crease-free and aesthetically appealing.

### BACKGROUND OF THE INVENTION

### Scope and Purpose

The stated invention relates to a fabric banner holder designed to be installed on a ceiling or wall surface for exhibiting flexible fabric banners. The banner holder facilitates ease of multiple banner replacement, without the need of sewing into the fabric stiffer material or provisions into the borders of the banner fabric with which stiffer materials can be inserted for rigidity. The requirement of a ladder for banner changes is also eliminated. The banner holder possesses a sliding unit with a sliding blocker provided therein, to cater to varying length specifications between is different banners.

### Brief Description of Current Banner Display Practices

A widely accepted form of advertising is to print patterns or characters on a fabric banner to a pre-determined size. Thereafter, the banner is placed or raised to a prominent location to draw attention to visitors passing by. Conventional fabric banners are divided into two distinct classes, vertical and horizontal fabric banners with the corresponding alignment of texts and images. Horizontal banners are normally suspended overhead at exhibition events, store fronts, or across election campaign offices. Suspended horizontal banners can be found affixed with makeshift hooks, ties and/or ropes to the ceiling or lower edge of any rigid signboard. Furthermore, counterweights are tied to the edges and corners of the banner's lower edge to keep the banners unfurled, introducing limited rigidity in when placed under strong indoor air circulation or outdoor breeze. These makeshift attachments and counterweights present a relative poor advertising image. Besides the high risk of openly suspended counterweights falling off and landing on visitors passing through, conventional banner setup often requires an appropriately sized ladder, increasing installation safety risks on elevated platforms.

Further to the stated installation safety issues, the rope to which the entire span of the banner is affixed could be feeding into a pulley system that raises the banner. Depending on the size of the banner and its corresponding weight, the pulley system may feature multiple loops of rope on multiple pulleys. Complex pulley systems add to costs. Besides costs, the presence of ropes and pulleys significantly reduces visual appeal and attractiveness of the banner on display. In an outdoor setting, strong winds will likely cause the banner to flap and deform, as the tension on rope holding the banner is compromised. Makeshift stoppers on the rope restrict the size of the banner and makes for difficult banner replacements. In addition, additional edge sewing in the banner is needed as provisions for the rope to thread over. Such provisions, when badly constructed, introduce creases and negatively impact banner display quality. Therefore, the need for an improved banner display device is required.

### SUMMARY OF THE INVENTION

In view of the above limitations and shortcomings in current display banner holders, this invention below is a novel fabric banner holder, capable of quick banner replacements and installation of varying banner sizes. The invention will see a banner holder installation that do not require additional banner edge sewing for rope provisions, nor ladder provisions for mounting the banner.

The novel fabric banner holder possesses two adjustment devices to be installed on ceiling or wall surfaces. The second adjusting device sits on a sliding rail base to facilitate movement along rail rods. Both adjustment devices possess rod tubes for generic fabric banner insertion along the banner edge. When both ends of the fabric banner are inserted onto the rod bodies of the first and second adjustment devices, a long rotating lever is applied in a circular rotating motion turning an interlocking gear, so that the sliding unit pulls and extends the rod tube out, with one edge of the banner stretching out. When the fabric banner is stretched out and in tension, the fabric banner will be smooth and crease free. The sliding blocker mounted on the sliding unit of the rod locks the sliding unit into place and holds the rod out, resulting in a stretched, smooth, and crease-free banner.

### BRIEF DESCRIPTION OF ACCOMPANYING DRAWINGS

FIG. 1 is a perspective view of the invention;

FIG. 2 is a schematic view of the structure of the invention;

FIG. 3 is a View (I) of detailed structure of the invention;

FIG. 4 is a View (II) of detailed structure of the invention;

FIG. 5 is a View (III) of detailed structure of the invention;

FIG. 6 is a schematic View (I) of the invention in use;

FIG. 7 is a schematic view (II) of the invention in use;

FIG. 8 is a schematic view (III) of the invention in use;

FIG. 9 is a schematic view (IV) of the invention in use;

FIG. 10 is a second detailed configuration of the invention;

FIG. 11 is a third detailed configuration of the invention.

### DETAILED DESCRIPTION OF ASSEMBLIES

The components in this invention, their technical specifications, as well as their functionalities are described in the set of illustrations and drawings of the sub-assembles and final assemblies.

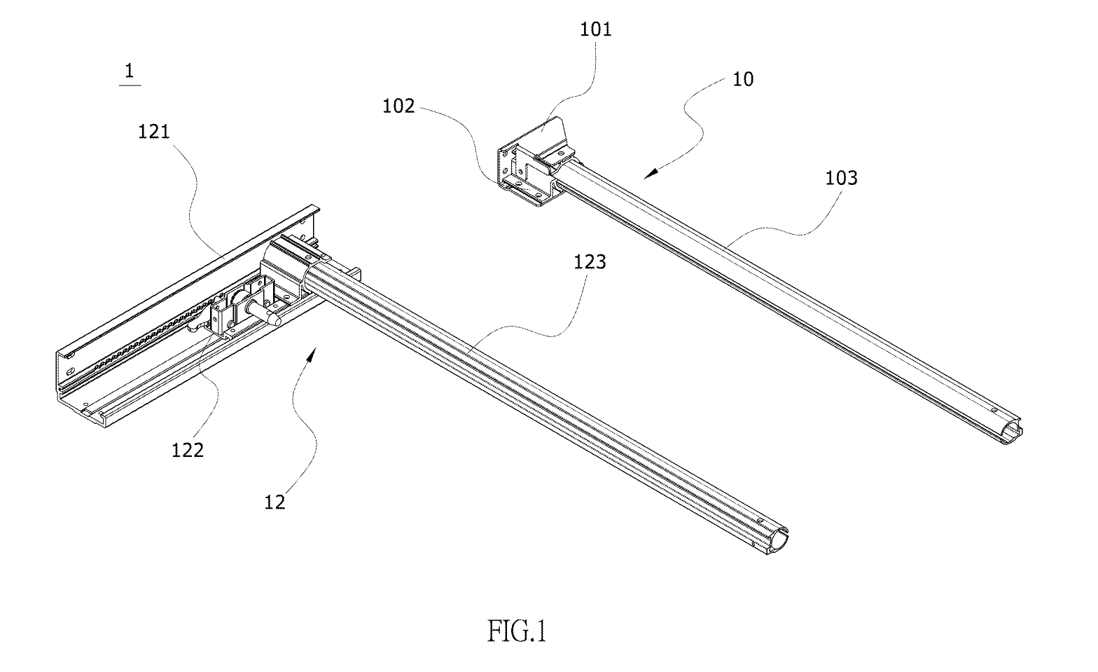

As illustrated in FIG. 1, the fabric banner holder sub-assembly device 1 of the present invention comprises an adjusting device 10 along with another adjusting device 12, which are to be installed on a ceiling or wall surface (not shown). The first adjusting sub-assembly device 10 has a base 101, a connecting member 102 and a rod body 103, which is inserted into the connecting member 102, and together assembled to the base 101. When one end of the fabric banner is fitted on the first rod body 103, the first rod body 103 is inserted into the first connecting member 102 so as to fix the one end of the fabric banner.

Referring to the FIG. 1 again, the fabric banner holder sub-assembly device 12 comprises a sliding rail base 121, a sliding unit 122 and a second rod body 123, into which the sliding unit 122 is assembled in the sliding rail base 121 so as to prevent the sliding unit 122, from easily detaching off sliding rail base 121. The sliding unit 122 of the present invention is attached to the sliding rail base 121 by insertion/embedding. Furthermore, the second rod body 123 is assembled on the sliding unit 122, so that the other end of the fabric banner can fitted on the second rod body 123. The sliding unit 122 enables the attached second rod body 123 to be pulled along in the lateral left or right directions. When the fabric banner is fitted into the second rod body 123, the banner can be stretched taut and crease-free, a significant improvement in banner display quality compared with the conventional structure of using rope to affix the fabric banner. In FIG. 1, both the first rod body 103 and the second rod body 123 can be constructed out of a hollow metal tube or aluminum extrusion, though the material use is not limited to the said types.

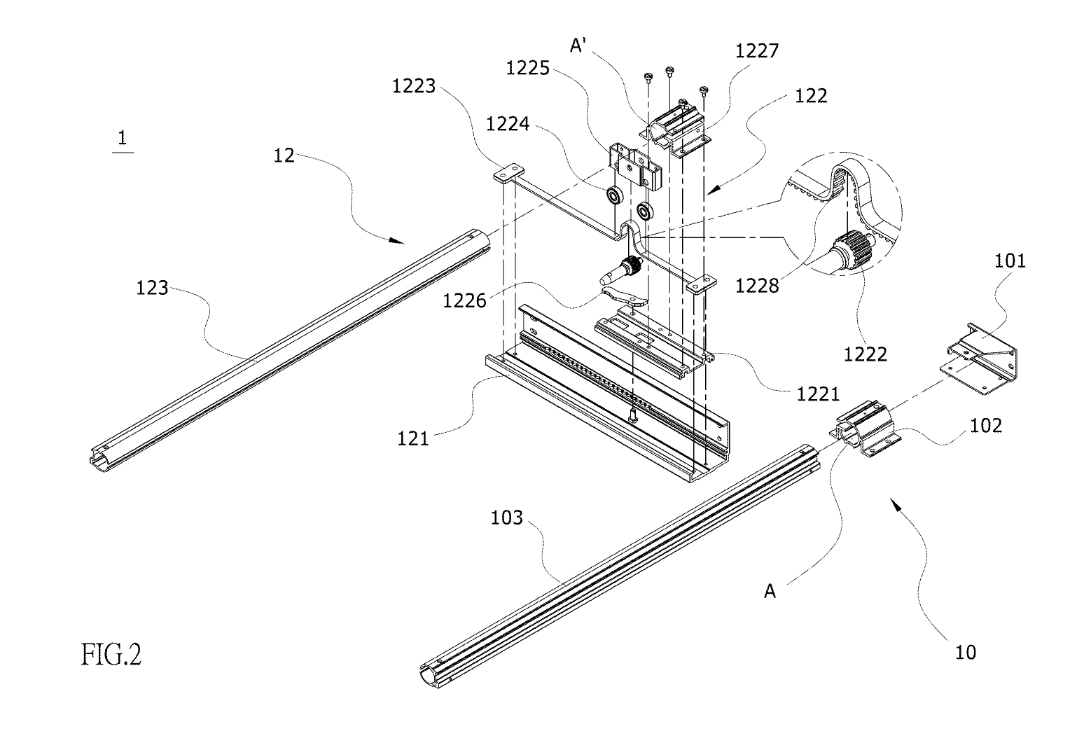

Referring to FIG. 2, with greater detail, the fabric banner holder sub-assembly device 1 of the invention comprises a first adjusting device 10 and a second adjusting device 12, wherein the first adjusting device 10 has a base 101, a connecting member 102 and a rod body 103. The connecting member 102 is assembled on the base 101, and the connecting member 102 is formed with an cavity space A for allow for insertion of the first rod body 103 designed for fitting and fixing of one end of a fabric banner.

Referring to FIG. 2 again, the second adjusting device 12 comprises a sliding rail base 121, a sliding unit 122 and a second rod body 123, in which the sliding unit 122 is inserted/embedded into the sliding rail base 121. The sliding unit 122 includes a base 1221, an interlocking gear 1222, an interlocking belt 1223, two ball bearings 1224, a bearing holder 1225, a positioning blocker 1226 and a second connecting member 1227, into which the positioning blocker 1226 and the second connecting member 1227 are attached onto the base 1221. Furthermore, a plate is affixed to the smooth side of the belt surface of the interlocking belt and both ends of the interlocking belt 1223 are fixed on the base 1221 with the plates. The grooved contact surface 1228 of the interlocking belt 1223 is meshed in sync onto the teeth the interlocking gear 1222. The bearing holder 1225 is fixed on the base 1221 and the interlocking gear 1222 is mounted into the bearing holder 1225 with rotating freedom of axis. Next, the two ball bearings 1224 are positioned on each side of the interlocking gear 1222 in such a manner to hold the interlocking belt 1223 in place on both sides to the interlocking gear 1222, so as to effectively prevent the interlocking belt 1223 from detaching from the teeth of the interlocking gear 1222.

Referring to FIG. 2 again, the second connecting member 1227 is assembled on the base 1221, and is formed an cavity space A for allow for insertion of the second rod body 123. Furthermore, the above second rod body 123 is provisioned for fitting of the other end of a fabric banner edge. When the interlocking gear 1222 is rotated by an external rotating torque, it will move the base 1221 in a lateral, horizontal motion, to enable the edge of fabric banner fitted on the second rod body 123 to displace. In this manner, the fabric banner can be effectively unfurled to along the length of the fabric banner into a taut, crease-free display for exhibition.

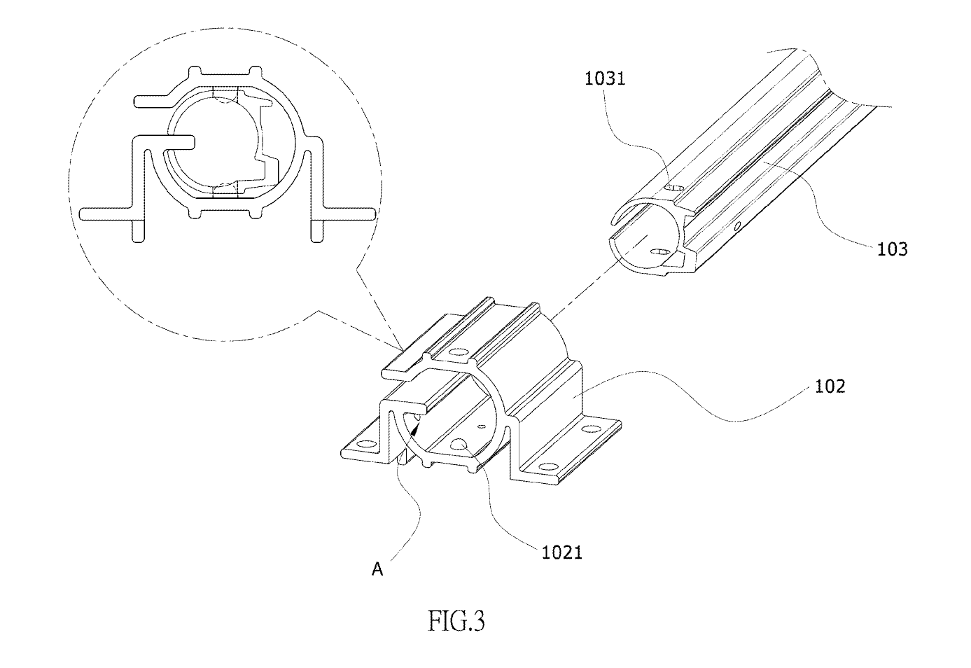

Referring to FIG. 3, the connecting member 102 is assembled with a cavity space A for the insertion of the first rod body 103 therein. At least one elastic positioning member 1021 assembled in the cavity space A, which can be a positioning ball, though not limited to this. On the other hand, the first connecting member 103 has a hole 1031. When the first rod body 103 is inserted in the first connecting member 103, the elastic positioning member 1021 is engaged and aligned to the through hole 1031, where another positioning member is inserted into hole 1031, ensuring that the first rod body 103 does not detach easily from the first connecting member 102. The assembly and the mounting method of the second connecting member 1227 and the second rod body 123 are identical to the assembly of the first connecting member 102 and the first rod body 103.

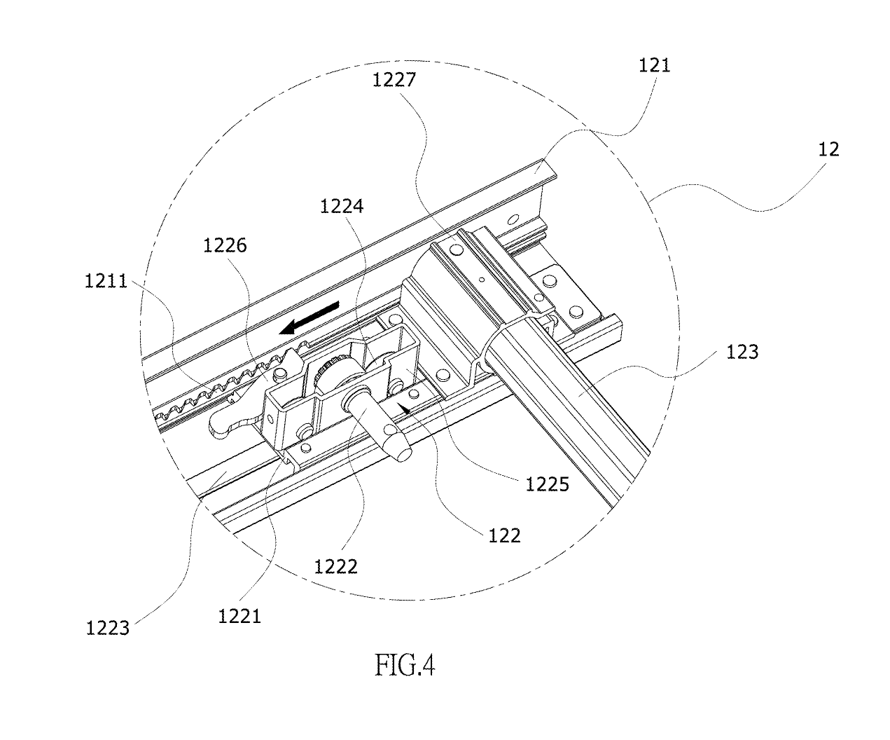

Referring to FIGS. 4 and 2, the second adjusting sub-assembly device 12 is formed with a sliding rail base 121, a sliding unit 122 and a second rod body 123, in which the sliding rail base 121 possesses grooves 1211. Furthermore, the sliding unit 122 includes a base 1221, an interlocking gear 1222, an interlocking belt 1223, two ball bearings 1224, a bearing holder 1225, a positioning blocker 1226 and a second connecting member 1227. After the second rod body 123 is inserted in the second connecting member 1227, the interlocking gear 1222 is rotated to displace in one direction (as shown by the arrow in figure), and the base 1221 is moved by the interlocking gear 1222 to facilitate linear motion in the sliding rail base 121, and then the sliding unit 122 is driven to perform a sliding motion. When the sliding unit 122 moves to an appropriate location, the positioning blocker 1226 will lock and engage into the positioning groove 1211, thereby facilitating fixed positioning.

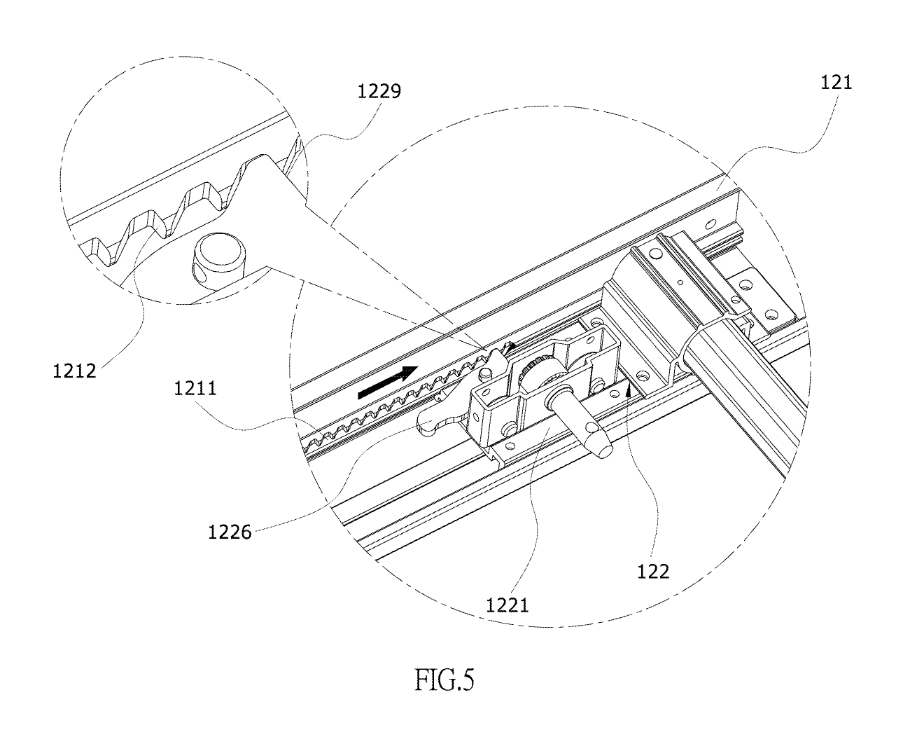

Next, referring to FIG. 5, when the sliding unit 122 moves into an appropriate location, the positioning blocker 1226 engages with the positioning groove 1211 of the sliding rail base 121. The positioning blocker 1226 has a stopper 1229. When an external force is applied (as shown by arrow in the figure), the stopper 1229 will push against one side wall 1212 of the positioning groove 1211, to prevent the base 1221 from displacement in left-right direction. This facilitates fixture of the entire sub-assembly and the holder, keeping the fabric banner taut.

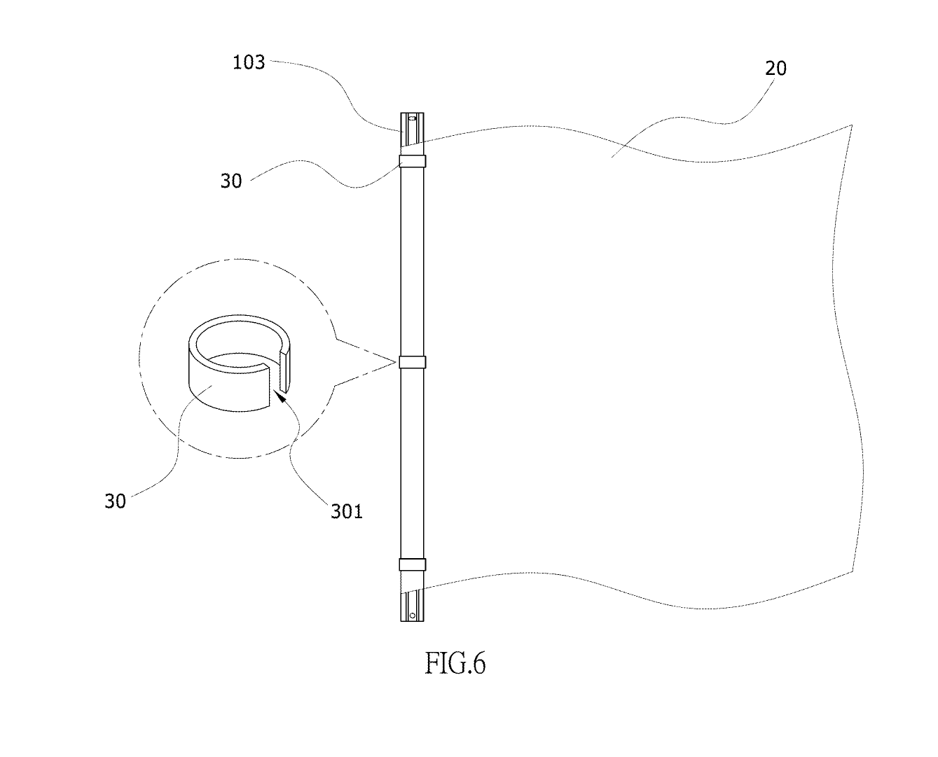

Referring to FIG. 6, when one end of the fabric banner 20 is fitted in the first rod body 103, one or more C type retaining ring 30 can be used to fix the one end of the fabric banner 20 on the first rod body 103 in retaining mode. As the C type retaining ring 30 has elasticity, when the C type retaining ring 30 is installed on the first rod body 103, the fabric banner 20 is held tightly in position, preventing the fabric from loosening and falling. When the fabric banner 20 is replaced, only the open end of the C type retaining ring 30 is enlarged with pliers, then the C type retaining ring 30 can be removed. In this way, an operator can achieve quick and easy installation and removals of the C type retaining ring 30 as required. Similarly, the other end of the fabric banner 20 is installed in in a similar stated above in FIG. 6.

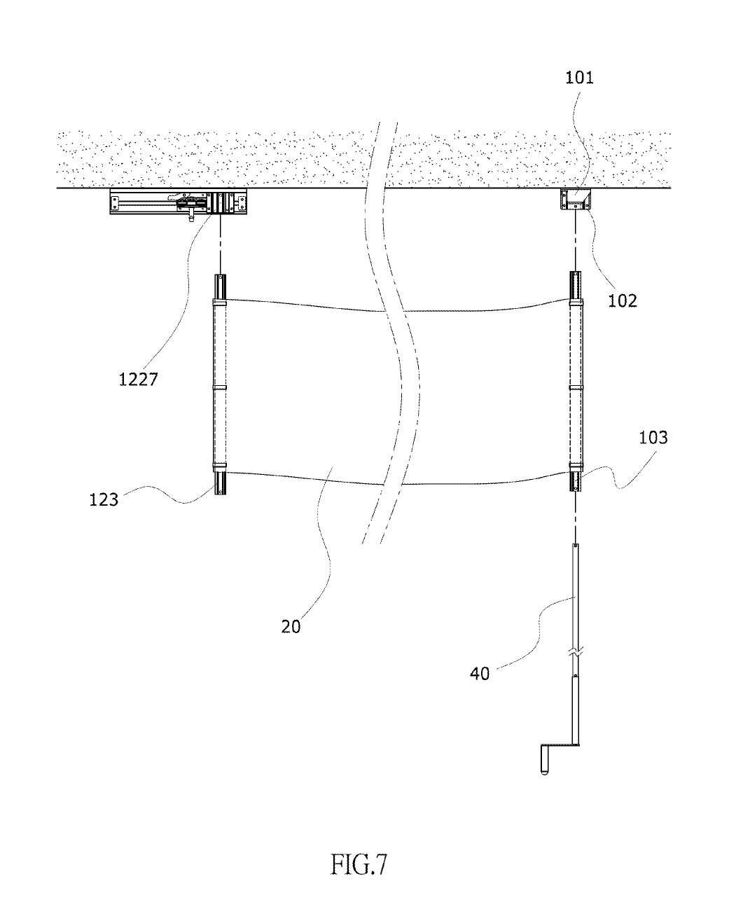

Referring to FIGS. 7 and 2, after both ends of the fabric banner 20 are fitted on the first rod body 103 and the second rod body 123 respectively, an rotating lever rod 40, serving as an extension rod, is inserted through the first rod body 103 prior to fabric banner installs, to facilitate connection and insertion of first rod body 103 to the first connecting member 102, which is pre-attached onto the base 101 affixed to a ceiling or wall surface. After the first rod body 103 is inserted in the first connecting member 102, the rotating lever rod 40, again as an extension rod, is used to insert the second rod body 123 in the second connecting member 1227 in a similar said manner above. In this way, the user can suspend the fabric banner 20 easily on ceiling by using rotating lever 40. Therefore, the risk of working on an elevated platform or ladder for banner replacements and installations can be significantly reduced.

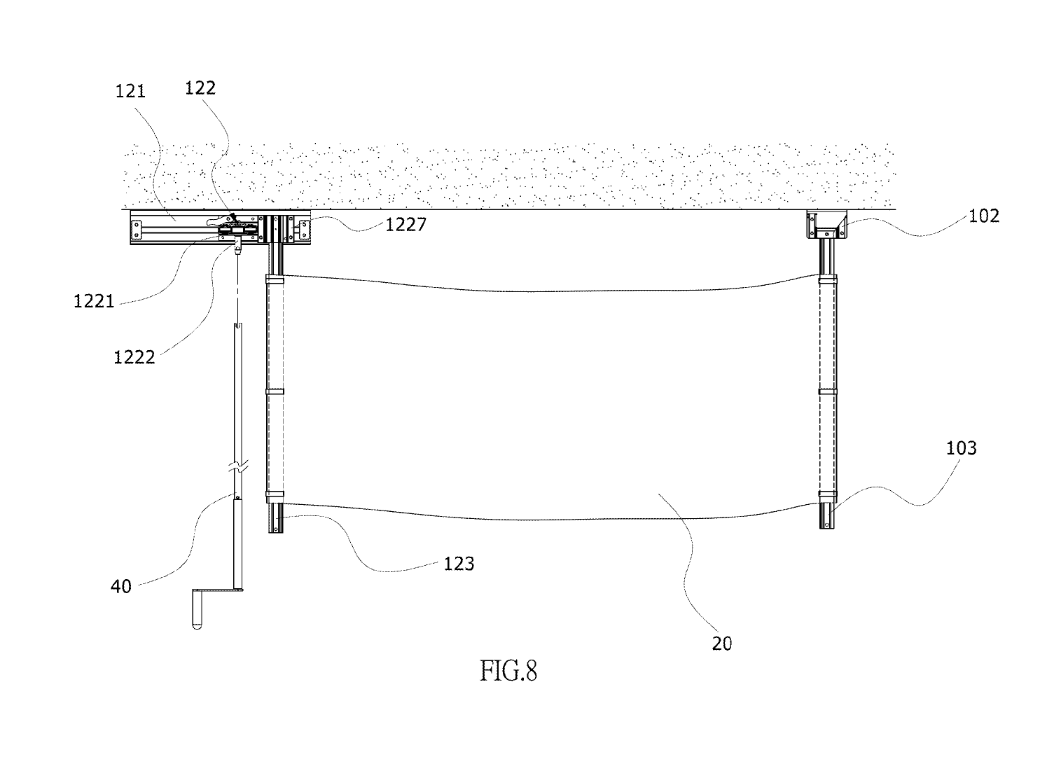

Referring to FIG. 8, after both ends of the fabric banner are fitted on the first rod body 103 and the second rod body 123 and inserted into the first connecting member 102 and the second connecting member 1227 respectively, the same rotating lever rod 40 is used to rotate the interlocking gear 1222 that drives the base 1221 on a linear motion along the sliding rail base 121, so that one end of the fabric banner fitted on the second rod body 123 is displaced.

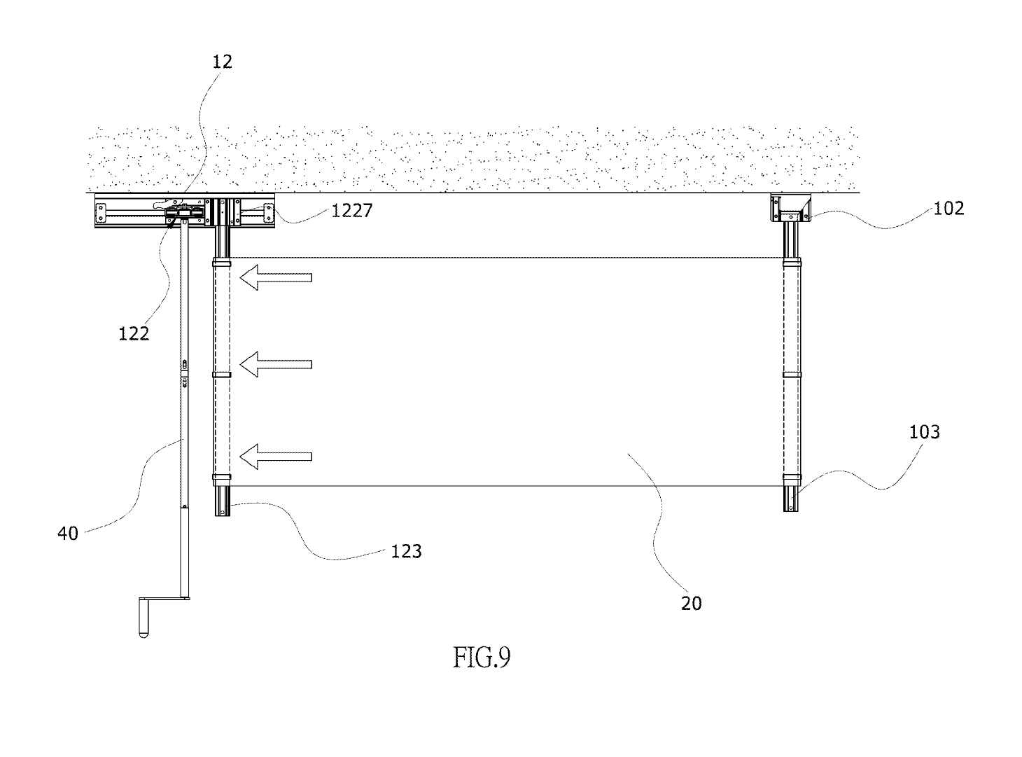

Referring to FIG. 9, after both ends of the fabric banner are fitted on the first rod body 103 connected to connecting member 102, and the second rod body 123 connected to connecting member 1227 with the rotating lever rod 40 as an extension rod, the rotating lever rod 40 is rotated to linearly displace the sliding unit, pulling the fabric banner 20 taut, as shown in the FIG. 9. Therefore, user can stretch the fabric banner tightly by the second adjusting device 12 according to the dimension of the fabric banner 20, for an appealing banner display.

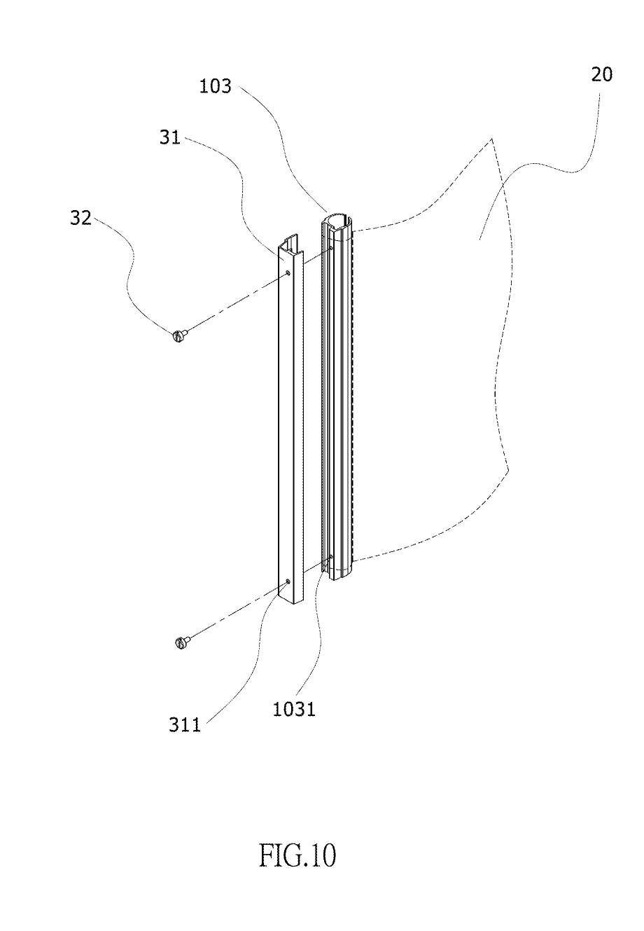

Referring to FIG. 10, when one end of the fabric banner 20 is fitted on the first rod body 103, aligned to the holes 1031, a clip 31 is used to clamp the fabric banner 20 onto the first rod body 103. Furthermore, the clip 31 is aligned with positioning holes 311. When one end of the fabric banner 20 is clamped on the first rod body 103 by the clip 31, a fastening element 32 is used to fasten clip 31 to first body rod 103, penetrating through the positioning holes 311 and holes 1031 of the first rod body 103 to firmly secure both sides of the fabric banner 20 to first rod body 103. The other end of the fabric banner 20 is installed in in a similar manner as above.

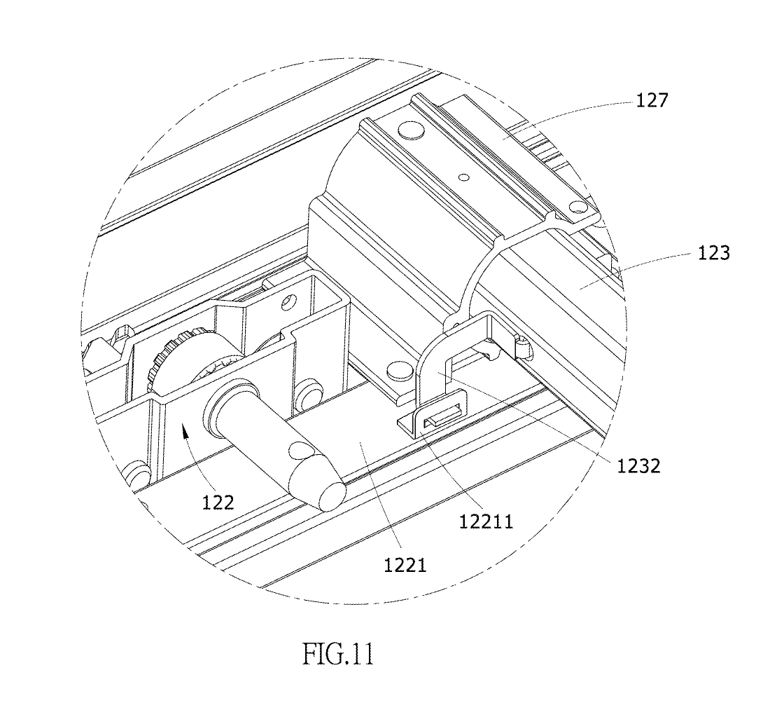

Referring to FIG. 11 and FIG. 2, a retaining male element 1232 is further assembled near the top end position of the second rod body 123, and a corresponding retaining female element 12211 is assembled on the base 1221 of the sliding unit 122. After the retaining male element 1232 is engaged with the corresponding retaining female element 12211, the second rod body 123 can be fitted more securely on the second connecting member 1227 as shown in the FIG. 11. With the added locking feature, the sliding unit 122 is more securely fastened to connecting member 1227 during the sliding motion and thereafter being held in position and in tension as the flag remains taut over an extended period. The added locking feature is similarly found in the first connecting member 102 installation to the first rod body 103.

Following from the above, the fabric banner holder presented in this invention has a first adjusting device as well as a second adjusting device, which are installed on ceiling or wall surface. After one end of the fabric banner is fitted on the first rod body of the first adjusting device and the other end is fitted on the second rod body of the second adjusting device, the sliding unit provided in the second adjusting device is moved so as to slide the second rod body assembly to stretch out the fabric banner, making it taut for display. The second adjusting device is formed by a sliding rail base, a sliding unit and a second rod body. The sliding unit has an interlocking belt with mesh teeth that engages with an interlocking gear teeth, installed within a bearing holder, while the bearing holder is affixed on a base. When the user uses a rotating lever to rotate the interlocking gear to move the sliding unit in one direction, the assembly attached to the gear travels along the base in a translating motion. The sliding unit possesses a positioning locking block, such that when the sliding unit moves to an appropriate location, the positioning blocker engages with the sliding rail base to lock in the position. This feature in the present invention as described above of fabric banner holder will enable the fabric banner with various length dimensions to be unfurled, lightly stretched and displayed in full quickly.

While the present invention has been illustrated with accompanying drawings, the configurations and the drawings are for descriptive and illustrative purposes. It is not intended to restrict the scope of the present invention. Variations and modifications may be undertaken and yet fulfilling the primary function of the fabric banner holder invention presented herein.

What is claimed is:

1. A fabric banner holder for stretching a fabric banner to a crease-free, taut and flat condition, comprising:
a first adjusting device having a base, a first connecting member and a first rod body, with the first connecting member being assembled onto said base, and the first rod body being inserted into the first connecting member;
a second adjusting device including a sliding rail base, a sliding unit sub-assembly and a second rod body. The said sliding unit sub-assembly comprises a base, an interlocking gear, an interlocking belt, two ball bearings, a bearing holder, a positioning blocker and a second connecting member, such that (i) the positioning blocker and the second connecting member are assembled on said base as a small sub-assembly, that (ii) the second connecting member fitting through to the second rod body, and that (iii) the grooves in the interlocking belt meshes in sync with the interlocking gear teeth, and the two ball bearings mounted along the interlocking belt adjacent to both faces of the interlocking gear, protected within a bearing holder;
wherein both edges of fabric banner are affixed to the first rod body and second rod body respectively; when a rotating lever is used to rotate the interlocking gear, the two ball bearings in the second adjusting device sub-assembly roll onto the interlocking belt to initiate translating motion, with sliding unit moving the second rod body in a direction away from the first adjusting device, stretching the fabric banner and making it taut.

2. The fabric banner holder as referenced in claim 1, with both the first and second connecting members, have space provisions for inserting the first and second rod body respectively, with locating holes in each rod body to locate and hold the fabric banner.

3. The fabric banner holder as referenced in claim 1, where one surface of interlocking belt with mesh grooves is meshed to the teeth of interlocking gear, when the interlocking belt is engaged with the gear.

4. The fabric banner holder as referenced in claim 2, where the space provisions of the first and second connecting members are each sub-assembled with one or more elastic positioning members, and the first rod body and second rod body are inserted into these space provisions. The elastic positioning members are aligned to fit through the holes in the first and second rod bodies.

5. The fabric banner holder as referenced in claim 1, in which the sliding rail base contains positioning grooves for engaging and locking into place the positioning blocker to keep the second adjusting device sub-assembly locked into place, preventing any unwanted lateral movements.

6. The fabric banner holder as referenced in claim 1, such that both ends of the fabric banner are fitted into first rod body and second rod body, affixed with C-type retaining rings.

7. The fabric banner holder as referenced in claim 2, such that upon the ends of said fabric banner fixed to the first rod body and second rod body, the fabric banner edges are then clamped onto the first rod body and second rod body with clips aligned to the positioning holes, where fasteners are used to lock the banner into place along the rod bodies with the positioning holes.
